(19) United States
(12) Patent Application Publication
(10) Pub. No.: US 2010/0161354 A1
(43) Pub. Date: Jun. 24, 2010

(54) SYSTEM AND METHOD OF PROVIDING HEALTH CARE USING UNIVERSAL HEALTH PLATFORM

(76) Inventors: Joon Ho LIM, Daejeon (KR); Ho Youl JUNG, Daejeon (KR); Min Ho KIM, Daejeon (KR); Soo Jun PARK, Seoul (KR); Seon Hee PARK, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/505,094

(22) Filed: Jul. 17, 2009

(30) Foreign Application Priority Data
Dec. 22, 2008 (KR) 10-2008-0131606

(51) Int. Cl. G06Q 50/00; H04B 7/00

(52) U.S. Cl. 705/3; 705/2; 455/41.2

(57) ABSTRACT

A health care system and method using a personal health device (PHD)-based universal health platform in a ubiquitous environment are disclosed. In order to measure health record by a PHD used by a user and automatically provide it so as to be used for various health care services via platforms, the health care system includes a measurement platform for collecting PHD standard personal health data from one or more PHDs, converting the collected data into clinical document architecture (CDA) standard data, and transmitting the converted data to an information collecting platform; and the information collecting platform for generating composite CDA standard data by using the received CDA standard data and providing the generated composite CDA standard data to services.

### CROSS-REFERENCE TO RELATED APPLICATIONS

This application claims the priority of Korean Patent Application No. 2008-131606 filed on Dec. 22, 2008, in the Korean Intellectual Property Office, the disclosure of which is incorporated herein by reference.

### BACKGROUND OF THE INVENTION

1. Field of the Invention

The present invention relates to a system and method of providing health care using a universal health platform based on a personal health device (PHD) in a ubiquitous environment, and more particularly, to a health care system and method in a ubiquitous environment capable of measuring health record by a user's PHD and automatically providing the measured health data to various health care services via a platform.

2. Description of the Related Art

With the increase in awareness of and concern for health maintenance, many technologies for more efficient healthcare have recently been studied. Technologies that fuse health devices capable of checking an individual's personal health, for instance, blood pressure manometers, blood glucose meters, body fat meters, etc., with information technologies, such as fall detection sensors, medication adherence sensors, and electrocardiographic sensors, have been continuously developed.

In spite of the development of various personal health devices, health problems in some parts of the human body may cause fatal damage to the individual health. Therefore, a technique of synthetically managing information on the various health devices is required.

There are known health device related international standards, one of which is ISO/IEEE 11073 Personal Health Device (PHD) (hereinafter, referred to as “PHD standard”). Further, there are known medical information related international standards, one of which is Health Level Seven (HL7).

The purpose of the PHD standard is for providing interoperability between personal health devices. The PHD standard defines the specialization of each personal health device over an ISO/IEEE 11073-20601 based standard such that personal health devices can be operated in a plug-and-play mode.

The HL7 standard is an international standard primarily used in Electronic Health Record (EHR) systems for hospitals, and provides clinical and health data related standards. The HL7 standard is generally composed of V2 message and V3 Clinical Document Architecture (CDA).

In spite of the efforts aimed at the standardization of integrated healthcare management, a system for integrally and collectively managing an individual's various health devices has not yet been constructed.

### SUMMARY OF THE INVENTION

An aspect of the present invention provides a platform for transmitting data measured by individual personal health devices (PHDs) to various services, and supporting a service for configuring data measured by a plurality of PHDs for each user.

Another aspect of the present invention provides a health care system and method capable of maintaining a data level compatibility with diverse services by applying a technique that converts health care device data collected according to a personal health device (PHD) standard, an international standard for health care devices, into a health level 7 (HL7) clinical document architecture (CDA) standard, an international standard for medical information.

According to an aspect of the present invention, there is provided a health care system using a universal health platform, including: a measurement platform that collects personal health device (PHD) standard personal health data from one or more PHDs, converts the personal health data into clinical document architecture (CDA) standard data, and transmits the converted CDA standard data to an information collecting platform; and the information collecting platform that generates composite CDA standard data by using the received CDA standard data and provides the composite CDA standard data to a service.

The measurement platform may include: a PHD message processing module that analyzes the PHD standard personal health data transmitted from the one or more PHDs; and a health level 7 (HL7) CDA conversion module that converts PHD measurement data of an event report analyzed by the PHD message processing module into CDA standard data.

The measurement platform may further include a code mapping table that stores values of LOINC and SNOMED CT corresponding to TYPE attributes of PHD objects.

The CDA standard data may include a header that describes meta information and a body that describes measurement data, and the meta information may include an ID, a model name, and a software name of each PHD. The body may store personal health record transferred via the event report.

The information collecting platform may include: a valid CDA generating module that generates a valid CDA document from the received CDA standard data; and a composite CDA generating module that generates a composite CDA standard data from the valid CDA document.

The valid CDA generating module may generate the valid CDA document by adding user information and agency (i.e., institution, organization, facilities, etc.) information to the received CDA standard data, and the composite CDA standard data may include composite CDA standard data of each user and composite CDA standard data of each device.

The one or more PHDs and the measurement platform may communicate according to one communication method among Zigbee, Bluetooth™, Wi-Fi, USB, and RS-232 (Recommended Standard 232), and the measurement platform and the information collecting platform may communicate according to a Java message service (JMS) or a TCP/IP.

According to another aspect of the present invention, there is provided a health care method using a universal health platform, including: receiving personal health data based on a personal health device (PHD) standard which has been collected from a plurality of PHDs via a measurement platform; analyzing the received personal health data based on the PHD standard and converting the data into CDA standard data; transmitting the converted CDA standard data to an information collecting platform; and generating composite CDA standard data by using the received CDA standard data.

The converting of the personal health data into the CDA standard data may include: analyzing and processing the received PHD standard personal health data; and converting measurement data of the PHDs in an event report of the health data into CDA standard data.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram illustrating the configuration of a health care system using a personal health device (PHD)-based universal health platform according to an exemplary embodiment of the present invention;

FIG. 2 is a detailed block diagram illustrating a measurement platform according to an exemplary embodiment of the present invention; and

FIG. 3 is a detailed block diagram illustrating an information collecting platform according to an exemplary embodiment of the present invention.

### DETAILED DESCRIPTION OF THE PREFERRED EMBODIMENT

The present invention will now be described more fully with reference to the accompanying drawings, in which exemplary embodiments of the invention are shown. Detailed descriptions of known functions and components will be omitted when it is deemed that such description would detract from the clarity and conciseness of the disclosure of the present invention.

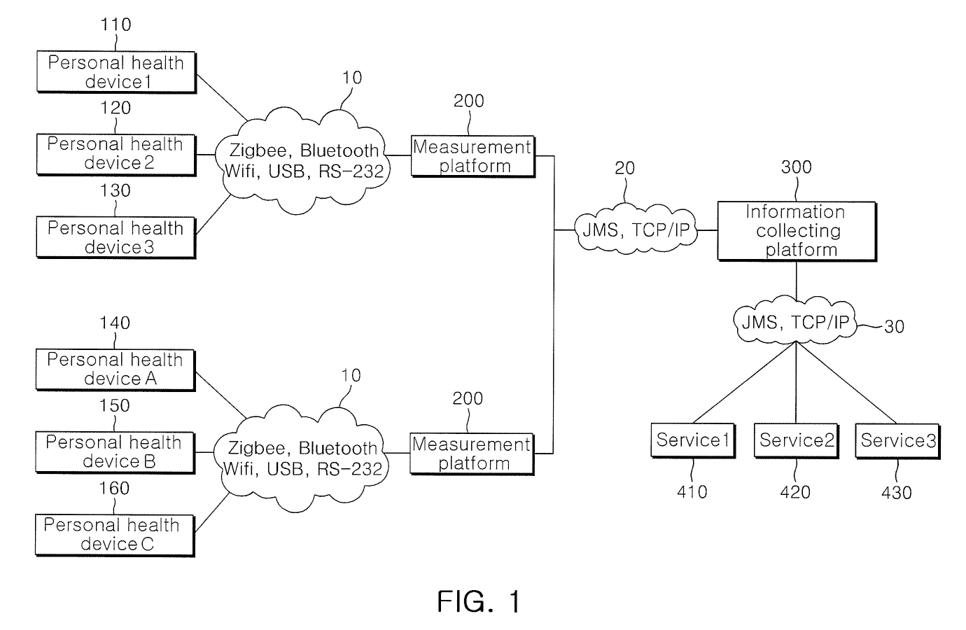

FIG. 1 is a schematic block diagram illustrating the configuration of a health care system using a personal health device (PHD)-based universal health platform according to an exemplary embodiment of the present invention.

As illustrated, the health care system using a PHD-based universal health platform includes one or more personal health devices (PHDs) 110 to 160, measurement platforms 200, and an information collecting platform 300. Health-related information is collected from the PHDs 110 to 160 by using the measurement platforms 200 installed in personal living spaces and then transmitted to the information collecting platform 300 to integratively manage the health-related information. Services 1, 2, and 3 410 to 430 requiring the health-related information may use the personal health-related information through communication with the information collecting platform 300 to provide a service.

The PHDs 110 to 160 measure personal health data at home or in a mobile environment. The PHDs 110 to 160 include equipment such as a fall detection sensor, a medication adherence sensor, a bio-patch for electrocardiogram measurements, or the like, which is to fuse a device, such as a blood pressure manometer, a blood glucose meter, a body fat meter, etc., with information technology.

The PHDs 110 to 160 operate based on ISO/IEEE PHD international standards. In addition, the PHDs 110 to 160 transmit the collected data to the measurement platforms 200 by using radio (i.e., wireless) communication protocols such as Zigbee, Bluetooth™, or Wi-Fi, or a wireline (i.e., wired) communication protocols such as USB or RS-232 (Recommended Standard 232).

The measurement platforms 200 collect data from the PHDs 110 to 160 which use diverse wired/wireless communications. The measurement platforms 200, which are installed in areas such as home or fitness clubs (i.e., health clubs) where users live, collect the data of nearby compatible PHDs over PHD standard, and convert the collected data into a HL7 CDA format of the international clinical standard.

The measurement platforms 200 transmit the converted CDA standard data to the information collecting platform 300 to integrally and collectively manage the health-related information.

The measurement platforms 200 support wired/wireless communication protocols of Zigbee, Bluetooth™, Infrared data association (IrDA), Ethernet, USB, and RS-232, which are most commonly used for personal health equipment. In addition, the measurement platforms 200 communicate with the information collecting platform 300 by JMS or TCP/IP.

The information collecting platform 300 configures measurement data by user or by the device required for the services 410, 420, and 430, based on the data which has been collected from the measurement platforms 200. By doing that, the information collecting platform 300 serves to transfer health-related information required by the services 410, 420, and 430.

The information collecting platform 300 performs communication by JMS or TCP/IP.

Upon receiving the personal health data which has been measured by the PHDs 110 to 160, the services 410, 420, and 430 perform intended services. The personal health-based services may include remote/video medical examination and treatment, security environment monitoring, emergency patient management, medicine administering caregivers, silver care self-health management, rehabilitation programs for the elderly, and the like.

Although not shown, a management server is provided to manage the settings required for a universal health platform. Content set by a manager is stored in a database, and the information collecting platform 300 collects data measured by the PHDs 110 to 160 via the corresponding content, and transfers the collected data to the services.

The management server manages the PHDs 110 to 160, the measurement platforms 200, the information collecting platform 300, and the services 410, 420, and 430.

Management of the PHDs 110 to 160 includes a device type management and a device instant management.

Management of the measurement platforms 200 includes an installation spot and connection management, CDA header management, and measurement terminal platform monitoring.

Management of the information collecting platform 300 includes user information management, device management of each user, user management of each device, composite CDA generation management, and information collecting platform monitoring.

Management of the services 410 to 430 includes service registration and connection management and composite CDA designation management of each service.

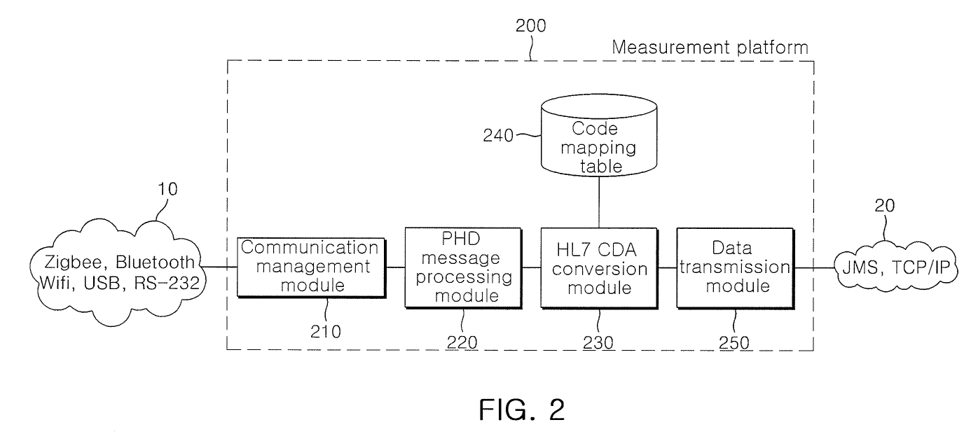

FIG. 2 is a detailed block diagram illustrating the measurement platform according to an exemplary embodiment of the present invention.

The measurement platform 200 includes a communication management module 210, a PHD message processing module 220, an HL7 CDA conversion module 230, a code mapping table 240, and a data transmission module 250.

The communication management module 210 manages communication with the PHDs 110 to 160 connected by each communication protocol. Namely, the communication management module 210 transfers messages received from the PHDs 110 to 160 to the PHD message processing module 220 and transmits a processing result message of the PHD message processing module 220 to a communication protocol to which a corresponding PHD is connected.

The PHD message processing module 220 processes a message received from a device according to the PHD standard, and transmits a processing result message to the PHD via the communication management module 210.

The PHD message processing module 220 processes messages such as an association request message, a configuration message, a get service message, an event report message, an association release message, and the like.

In methods for transmitting measurement data by the PHDs, the PHD message processing module 220 supports both an agent-initiated method and a manager-initiated method. When the PHDs include a PM-store or a scanner object, the PHD message processing module 220 sets to collect data of the PM-store and activate an operation state of the scanner to transmit data.

The PHD message processing module 220 transfers measurement data of the PHDs transmitted via the event report message to the HL7 CDA conversion module 230. The thusly transferred measurement data of the PHDs undergo an HL7 CDA format conversion, and then transferred to the information collecting platform 300. The following is an example of the event report message of the PHDs transferred to the HL7 CDA conversion module 230.

| | |
|---|---|
| 0xE7 0x00 | APDU CHOICE Type (PrstApdu) |
| 0x00 0x3A | CHOICE.length = 58 |
| 0x00 0x38 | OCTET STRING.length = 56 |
| 0x43 0x21 | invoke-id = 0x4321 (start of DataApdu. |
| | MDER encoded.) |
| 0x01 0x01 | CHOICE(Remote Operation Invoke \| Confirmed |
| | Event Report) |
| 0x00 0x32 | CHOICE.length = 50 |
| 0x00 0x00 | obj-handle = 0 (MDS object) |
| 0x00 0x00 0x00 0x00 | event-time = 0 |
| 0x0D 0x1D | event-type = |
| | MDC_NOTI_SCAN_REPORT_FIXED |
| 0x00 0x28 | event-info.length = 40 |
| 0xF0 0x00 | ScanReportInfoFixed.data-req-id = 0xF000 |
| 0x00 0x00 | ScanReportInfoFixed.scan-report-no = 0 |
| 0x00 0x02 | ScanReportInfoFixed.obs-scan-fixed.count = 2 |
| 0x00 0x20 | ScanReportInfoFixed.obs-scan-fixed.length = 32 |
| 0x00 0x01 | ScanReportInfoFixed.obs-scan-fixed.value[0]. |
| | obj-handle = 1 |
| 0x00 0x0C | ScanReportInfoFixed.obs-scan-fixed.value[0]. |
| | obs-val-data.length = 12 |
| 0xFF 0x00 0x02 0x70 | Simple-Nu-Observed-Value = 62.4 |
| 0x20 0x07 0x02 0x01 | Absolute-Time-Stamp = 2007-02-01T12:10:0000 |
| 0x12 0x10 0x00 0x00 | |
| 0x00 0x02 | ScanReportInfoFixed.obs-scan-fixed.value[1]. |
| | obj-handle = 2 |
| 0x00 0x0C | ScanReportInfoFixed.obs-scan-fixed.value[1]. |
| | obs-val-data.length = 12 |
| 0xFF 0x00 0x01 0x00 | Simple-Nu-Observed-Value = 25.6 |
| 0x20 0x07 0x02 0x01 | Absolute-Time-Stamp = 2007-02-01T12:10:0000 |
| 0x12 0x10 0x00 0x00 | |

The HL7 CDA conversion module 230 converts the personal health data transmitted as the PHD standard data into the HL7 CDA standard data and transfers the same.

The converted CDA includes a header that describes meta information and a body that describes the measurement data.

The header of the CDA that describes meta information is as follows. An ID and a model name of the device transferred from an MDS object of the PHD, a software name, and the like, are recorded in an extension ID of an author and an assignedAuthoringDevice. Information such as other IDs, code, agency information (custodian), and the like, is recorded in the CDA by using values previously set by the manager.

```
<?xml version=“1.0” encoding=“UTF-8”?>
<ClinicalDocument xmlns=“urn:h17-org:v3”>
  <typeId extension=“POCD_HD000040”
  root=“2.16.840.1.113883.1.3”/>
  <id root=“1.2.826.0.1.3680043.8.497.1”/>
  <code code=“11492-6” codeSystem=“2.16.840.113883.6.1”
codeSystemName=“LOINC” displayName=“History &amp; physical
note”/>
  <effectiveTime value=“20081008095517+0900”/>
  <confidentialityCode/>
  <recordTarget>
    <patientRole>
      <id root=“1.2.826.0.1.3680043.8.497.3”/>
      <addr></addr>
      <telecom use=“HP” value=“”/>
      <patient>
        <name></name>
        <administrativeGenderCode code=“”/>
      </patient>
    </patientRole>
  </recordTarget>
  <author>
    <time value=“20081008095517+0900”/>
    <assignedAuthor>
      <id extension=“11000001”
root=“1.2.826.0.1.3680043.8.497.5”/>
      <assignedAuthoringDevice>
        <manufacturerModelName>deviceModelName
</manufacturerModelName>
        <softwareName>deviceSoftwareName
</softwareName>
      </assignedAuthoringDevice>
    </assignedAuthor>
  </author>
  <custodian>
    <assignedCustodian>
      <representedCustodianOrganization>
        <id root=“1.2.826.0.1.3680043.8.497.7”/>
        <name></name>
        <addr></addr>
      </representedCustodianOrganization>
    </assignedCustodian>
  </custodian>
  <component>
    <structuredBody>
    ...
    </structuredBody>
  </component>
</ClinicalDocument>
```

Also, actual personal health record transferred via the event report of the PHD is recorded in the CDA body. The following is an example of the CDA body.

```
<structuredBody>
<component>
  <section>
    <code code=“29545-1” codeSystem=“2.16.840.1.113883.6.227”
codeSystemName=“LOINC” displayName=“Physical findings”/>
    <title>physical findings</title>
    <author>
      <time value=“20081008095517+0900”/>
      <assignedAuthor>
        <id extension=“11000001”
root=“1.2.826.0.1.3680043.8.497.5”/>
        <assignedAuthoringDevice>
          <manufacturerModelName>
deviceModelName </manufacturerModelName>
          <softwareName> deviceSoftwareName
</softwareName>
        </assignedAuthoringDevice>
      </assignedAuthor>
    </author>
    <entry>
      <observation classCode=“OBS” moodCode=“EVN”>
        <code code=“11289-6”
codeSystem=“2.16.840.1.113883.11.19341” codeSystemName=“LOINC”
displayName=“Body Temperature ”/>
        <effectiveTime value=“20081008095518+0900”/>
        <value value=“25.0”
xmlns:xsi=“http://www.w3.org/2001/XMLSchema-instance”
xsi:type=“PQ”/>
      </observation>
    </entry>
  </section>
</component>
</structuredBody>
```

In order to allow the information collecting platform 300 to integrate data measured by the PHDs, the HL7 CDA conversion module 230 describes the information of each PHD in a section and records the actually measured data in an observation attribute. Codes of each observation are converted with reference to the code mapping table 240, and the actual measurement values transferred via the event report are recorded as values. When a plurality of measurement values are transferred from the PHDs, a plurality of observation attributes are recorded.

The code mapping table 240 stores values of LOINC and SNOMED CT corresponding to each Type attribute of the PHD objects (here, the Type attributes of the PHD objects describe what values corresponding objects measure based on an ISO/IEEE 11073-10101 nomenclature value).

The HL7 CDA conversion module 230 allocates a proper code value to each measurement value of the objects transferred via the event report with reference to the corresponding information.

| PHD TYPE | codeSystem | codeSystemName | code | displayName |
|---|---|---|---|---|
| MDC_PART_SCADA\| | 2.16.840.113883.6.1 | LOINC | 11289-6 | Body Temperature |
| MDC_TEMP_BODY | | | | |
| . . . | | | | |

The CDA document converted thusly is transferred to the information collecting platform 300 via the data transmission module 250. For communication between the measurement platform 200 and the information collecting platform 300, TCP/IP-based JMS communication is used. When the measurement platform 200 is driven (i.e., operates), the data transmission module 250 performs connection to the information collecting platform 300, and then, each time the CDA document is converted, the data transmission module 250 transfers the converted CDA document to the information collecting platform 300.

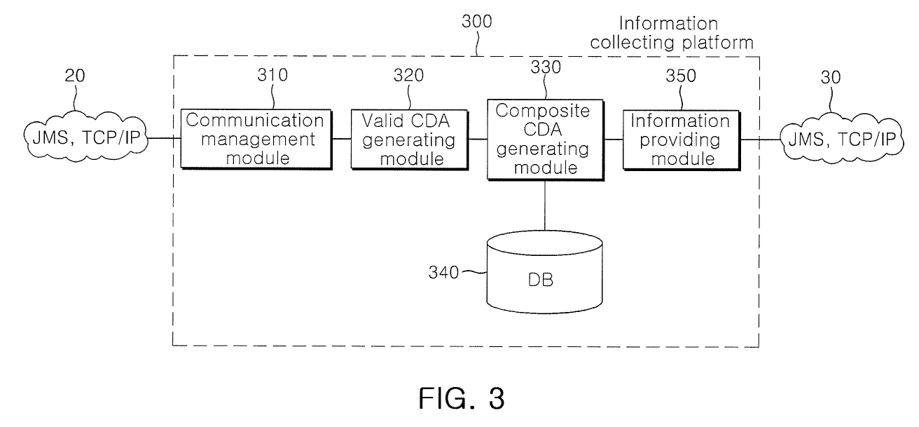

FIG. 3 is a detailed block diagram illustrating the information collecting platform according to an exemplary embodiment of the present invention.

The information collecting platform 300 includes a communication management module 310, a valid CDA generating module 320, a composite CDA generating module 330, and an information providing module 350.

The communication management module 310 manages the measurement platforms 200 which have requested for a connection to the information collecting platform 300, and collects CDA documents transferred from the measurement platforms 200.

The valid CDA generating module 320 adds user information (recordTarget) and agency information (custodian), etc., to the CDA document which has been converted by the measurement platform 200 to generate a valid CDA document. As the user information, user information allocated to each PHD is used. Namely, information such as user id, name, etc., corresponding to an extension attribute of an author id of the converted CDA document is added to the recordTarget. The user information, the agency information, and the like, are managed by a manager via a central management server (not shown), and the information collecting platform 300 accesses the corresponding information via communication with the management server. Only the single information collecting platform 300, rather than many information collecting platforms, is allowed to access the user and agency information, facilitating the management of accessing the corresponding information.

The composite CDA generating module 330 configures the measured personal health data as units required for a pertinent service. The composite CDA generating module 330 may perform two types of method: a user composite CDA generating method and a device composite CDA generating method.

In the user composite CDA generating method, measurement data of all the PHDs allocated to a certain user are configured as a single CDA document during a certain time period or until when reference device data is generated. In order to configure the measurement data from the plurality of devices as the single CDA document, a new section is generated for each device and the device information of corresponding sections is described as the author.

When a plurality of event reports are transferred from a single device, a new entry is generated for each event report.

Finally, when a plurality of measurement data is transferred in a single event report, a plurality of observations is described. Through such CDA document structure, the respective services can even recognize information about the unit based on the measurement data which has been transmitted from each device.

Meanwhile, in the device composite CDA generating method, data of a corresponding device is configured as a single CDA document during a certain time period or whenever measurement data is generated. Information of the corresponding device is described in the author of the section. A new entry is generated for each event report transferred from the device, and observations transferred via the event report are described in each entry.

Information about the method of configuring the composite CDA for each device or each user, information about a composite CDA configuration time, and the like, is managed by the manager via the management server (not shown). The information collecting platform 300 accesses the corresponding information via communication with the management server to thereby configure the composite CDA according to units required by the services.

The information providing module 350 transfers the composite CDA document configured for each user and each device to a service/services in need of it. The manager manages a service list and a connection method of each service via the management server (not shown), and designates composite CDA documents to be collected by services. When the information collecting platform 300 is driven, the information providing module 350 performs a connection to the registered services via the information set in the management server, and when the composite CDA document is generated, the information providing module 350 transmits the composite CDA document to the designated services.

As set forth above, according to exemplary embodiments of the invention, the health care system and method using a universal health platform have advantages in that because the health-related data of PHD standard health care devices is collected using the measurement platform installed in a living space of a user and transferred to the information collecting platform, the user's health-related information can be collectively and integratively managed and the information can be provided to a service that requires it.

Also, according to exemplary embodiments of the invention, the health care system and method using a universal health platform have advantages that since they are based on the PHD standards and HL7 CDA standards, the health care device according to the PHD standards may be easily engaged with the services according to the HL7 CDA standards.

While the present invention has been shown and described in connection with the exemplary embodiments, it will be apparent to those skilled in the art that modifications and variations can be made without departing from the spirit and scope of the invention as defined by the appended claims.

What is claimed is:

1. A health care system using a universal health platform, the system comprising:
a measurement platform that collects personal health device (PHD) standard personal health data from one or more PHDs, converts the personal health data into clinical document architecture (CDA) standard data, and transmits the converted CDA standard data to an information collecting platform; and
the information collecting platform that generates composite CDA standard data by using the received CDA standard data and provides the composite CDA standard data to a service.

2. The system of claim 1, wherein the measurement platform comprises:
a PHD message processing module that analyzes the PHD standard personal health data transmitted from the one or more PHDs; and
a health level 7 (HL7) CDA conversion module that converts PHD measurement data of an event report analyzed by the PHD message processing module into CDA standard data.

3. The system of claim 2, wherein the measurement platform further comprises a code mapping table that stores values of LOINC and SNOMED CT corresponding to TYPE attributes of PHD objects.

4. The system of claim 2, wherein the CDA standard data comprises a header that describes meta information and a body that describes measurement data.

5. The system of claim 4, wherein the meta information comprises an ID, a model name, and a software name of each PHD.

6 The system of claim 4, wherein the body stores personal health record transferred via the event report.

7. The system of claim 1, wherein the information collecting platform comprises:
a valid CDA generating module that generates a valid CDA document from the received CDA standard data; and
a composite CDA generating module that generates a composite CDA standard data from the valid CDA document.

8. The system of claim 7, wherein the valid CDA generating module generates the valid CDA document by adding user information and agency information to the received CDA standard data.

9. The system of claim 7, wherein the composite CDA standard data comprises composite CDA standard data of each user and composite CDA standard data of each device.

10. The system of claim 1, wherein the one or more PHDs and the measurement platform communicate according to one communication method among Zigbee, Bluetooth T, Wi-Fi, USB, and RS-232 (Recommended Standard 232).

11. The system of claim 1, wherein the measurement platform and the information collecting platform communicate according to a Java message service (JMS) or a TCP/IP.

12. A health care method using a universal health platform, the method comprising:
receiving personal health data based on a personal health device (PHD) standard which has been collected from a plurality of PHDs via a measurement platform;
analyzing the received personal health data based on the PHD standard and converting the data into CDA standard data;
transmitting the converted CDA standard data to an information collecting platform; and
generating composite CDA standard data by using the received CDA standard data.

13. The method of claim 12, wherein the converting of the personal health data into the CDA standard data comprises:
analyzing and processing the received PHD standard personal health data; and
converting measurement data of the PHDs in an event report of the health data into CDA standard data.

14. The method of claim 12, wherein the receiving of the personal health data via the measurement platform comprises: receiving the personal health data by using one communication method among Zigbee, Bluetooth™, Wi-Fi, USB, and RS-232 (Recommended Standard 232).
